(19) United States
(12) Patent Application Publication
(10) Pub. No.: US 2015/0081625 A1
(43) Pub. Date: Mar. 19, 2015

(54) SERVICE POLLING METHOD AND SYSTEM, AND COMPUTER STORAGE MEDIUM

(71) Applicant: Tencent Technology (Shenzhen) Company Limited, Shenzhen (CN)

(72) Inventors: Xing Li, Shenzhen (CN); Wei Xu, Shenzhen (CN); Wukui Shen, Shenzhen (CN); Wenying Xu, Shenzhen (CN); Ang Xu, Shenzhen (CN)

(73) Assignee: Tencent Technology (Shenzhen) Company Limited, Shenzhen (CN)

(21) Appl. No.: 14/395,667

(22) PCT Filed: Sep. 10, 2013
(86) PCT No.: PCT/CN2013/083198

§ 371 Date: Oct. 20, 2014

(30) Foreign Application Priority Data
Sep. 19, 2012 (CN) 201210349218.9

(51) Int. Cl. G06F 17/30

(52) U.S. Cl. CPC G06F 17/30289
USPC 707/609

(57) ABSTRACT

A method for service inspection includes: acquiring a changing operation on a service inspection project; acquiring a service process or port bound to the service inspection project according to the changing operation, looking up a corresponding server according to the service process or port, and updating an association relationship between the service inspection project and the server, to obtain a corresponding updated result; and publishing the updated result. A method, system and non-transitory computer-readable storage medium for service inspection, acquire a service process or port bound to the service inspection project according to the changing operation, look up a corresponding server according to the service process or port, update an association relationship between the service inspection project and the server to obtain a corresponding updated result, and publish the updated result, such that the service can be updated and maintained automatically.

### CROSS-REFERENCE TO RELATED APPLICATIONS

This application claims the benefit of Chinese Patent Application No. 201210349218.9 filed on Sep. 19, 2012, the contents of all of which are incorporated herein by reference in their entireties.

### FIELD

The present disclosure relates generally to computer network technology, and more particularly, to a method and system for service inspection and non-transitory computer-readable storage medium thereof.

### BACKGROUND

With the development of computer network technology, computer networks have become a necessity in human life. A variety of services can be provided in a server to meet different requirements in a network. A “service” means a service to perform a certain function. The service on the server needs maintenance by operation staffs. For example, when a service is deployed to the server, the operations staff will deploy a matching monitor program at the same time; when the service is uninstalled from the server, the operations staff will stop the service and the matching monitor program; and when a server is decommissioned, the operations staff will stop all of the services in the server and all of the matching monitor programs.

The traditional service maintenance is mainly implemented manually by operations staff. As there are many different types of services and monitor programs, whenever there is a service to be deployed to a server, manual work is needed to deploy all of the matching monitor programs, which causes redundant work, and is easy to have misoperation in manual operation. When a service is put offline from a certain server or a server is decommissioned, the monitor program cannot automatically stop monitoring, and it needs manual intervention. When a monitor program needs to be upgraded, the original version of the monitor program should be replaced by hand, and at the moment it is difficult to know the servers where the monitor program has been deployed in, which causes difficulties in upgrading of the monitor program.

### SUMMARY

In view of the above, it is an object of the present disclosure to provide a method for service inspection, which can automatically maintain services and reduce personnel cost.

According to an aspect of the disclosure, a method for service inspection includes:

acquiring a changing operation on a service inspection project;

acquiring a service process or port bound to the service inspection project according to the changing operation, looking up a corresponding server according to the service process or port, and updating an association relationship between the service inspection project and the server, to obtain a corresponding updated result; and

publishing the updated result.

In one embodiment, the changing operation can be an adding, editing or deleting operation.

In one embodiment, after publishing the updated result, the method can further include:

traversing information regarding the service inspection project, information regarding the server, and the association relationship between the service inspection project and the server regularly;

and updating an association relationship between the service inspection project and the server according to a result of traverse.

In one embodiment, updating an association relationship between the service inspection project and the server according to a result of traverse includes:

deleting an association relationship in relation to the server when the server is invalid or the server cannot be found;

deleting an association relationship between the server and the corresponding service inspection project when a server port does not match the port bound to the service inspection project or the service process in the server does not match the service process bound to the service inspection project; and

establishing an association relationship between a newly-added server and a corresponding service inspection project when adding the new server and there is no association relationship between the new server and the corresponding service inspection project.

In one embodiment, before traversing information regarding the service inspection project, information regarding the server, and the association relationship between the service inspection project and the server regularly, the method further includes:

setting up a deleting queue and an adding queue;

moving an association relationship in relation to the server to the deleting queue when the server is invalid or the server cannot be found;

moving an association relationship between the server and the corresponding service inspection project to the deleting queue when a server port does not match the port bound to the service inspection project or the service process in the server does not match the service process bound to the service inspection project;

moving an association relationship between a newly-added server and a corresponding service inspection project when adding the new server and there is no association relationship between the new server and the corresponding service inspection project;

traversing the deleting queue, and deleting an association relationship between a server and a corresponding service inspection project in the deleting queue; and

traversing the adding queue, and adding an association relationship between a server and a corresponding service inspection project in the adding queue.

In one embodiment, before acquiring a changing operation on a service inspection project, the method further includes:

storing information regarding the service inspection project, information regarding the server, and an association relationship between a service inspection project and a server into a service inspection database.

In one embodiment, before acquiring a changing operation on a service inspection project, the method further includes:

categorizing servers and marking up each category of servers;

wherein the step of acquiring a service process or port bound to the service inspection project according to the changing operation, looking up a corresponding server according to the service process or port, and updating an association relationship between the service inspection project and the server, to obtain a corresponding updated result, includes:

acquiring a service process or port bound to the service inspection project according to the changing operation, looking up a corresponding server according to the service process or port, and updating an association relationship between the service inspection project and each category of servers, to obtain a corresponding updated result.

In one embodiment, after publishing the updated result, the method further includes:

acquiring a query request; and

viewing the updated association relationship between the service inspection project and the server according to the query request.

It is another object of the present disclosure is to provide a system for service inspection, which can automatically maintain services and reduce personnel cost.

According to a further aspect of the disclosure, a system for service inspection includes:

an interaction module, configured to acquire a changing operation on a service inspection project;

a processing module, configured to acquire a service process or port bound to the service inspection project according to the changing operation, look up a corresponding server according to the service process or port, and update an association relationship between the service inspection project and the server, to obtain a corresponding updated result; and

a publishing module, configured to publish the updated result.

In one embodiment, the changing operation can be an adding, editing or deleting operation.

In one embodiment, the system for service inspection further includes:

a scanning module, configured to traverse information regarding the service inspection project, information regarding the server, and the association relationship between the service inspection project and the server regularly.

The processing module is also configured to update an association relationship between the service inspection project and the server according to a result of traverse.

In one embodiment, the processing module is also configured to delete an association relationship in relation to the server when the server is invalid or the server cannot be found, delete an association relationship between the server and the corresponding service inspection project when a server port does not match the port bound to the service inspection project or the service process in the server does not match the service process bound to the service inspection project, and establish an association relationship between a newly-added server and a corresponding service inspection project when adding the new server and there is no association relationship between the new server and the corresponding service inspection project.

In one embodiment, the system for service inspection further includes:

a setting module, configured to set up a deleting queue and an adding queue.

The processing module is also configured to move an association relationship in relation to the server to the deleting queue when the server is invalid or the server cannot be found, move an association relationship between the server and the corresponding service inspection project to the deleting queue when a server port does not match the port bound to the service inspection project or the service process in the server does not match the service process bound to the service inspection project, and move an association relationship between a newly-added server and a corresponding service inspection project when adding the new server and there is no association relationship between the new server and the corresponding service inspection project.

The scanning module is also configured to traverse the deleting queue, and the processing module is also configured to delete an association relationship between a server and a corresponding service inspection project in the deleting queue.

The scanning module is also configured to traverse the adding queue, and the processing module is also configured to add an association relationship between a server and a corresponding service inspection project in the adding queue.

In one embodiment, the system for service inspection further includes:

a service inspection database, configured to store information regarding the service inspection project, information regarding the server, and an association relationship between a service inspection project and a server.

In one embodiment, the system for service inspection further includes:

a categorizing module, configured to categorize servers; and a marking module, configured to mark up each category of servers.

The processing module is also configured to acquire a service process or port that is bound to the service inspection project according to the changing operation, look up a corresponding server according to the service process or port, and update an association relationship between the service inspection project and each category of servers, to obtain a corresponding updated result.

In one embodiment, the interaction module is also configured to acquire a query request, and view the updated association relationship between the service inspection project and the server according to the query request.

It is still a further object of the present disclosure is to provide a non-transitory computer-readable storage medium.

According to a further aspect of the disclosure, one or more non-transitory computer-readable storage mediums comprise an executable program to execute a method for service inspection, and the method includes:

acquiring a changing operation on a service inspection project;

acquiring a service process or port bound to the service inspection project according to the changing operation, looking up a corresponding server according to the service process or port, and updating an association relationship between the service inspection project and the server, to obtain a corresponding updated result; and

publishing the updated result.

The above method, system and non-transitory computer-readable storage medium for service inspection, acquire a service process or port bound to the service inspection project according to the changing operation, look up a corresponding server according to the service process or port, update an association relationship between the service inspection project and the server to obtain a corresponding updated result, and publish the updated result, such that the service can be updated and maintained automatically to liberate operations staff from redundant work and reduce personnel cost.

### BRIEF DESCRIPTION OF THE DRAWINGS

FIG. 1 is a flow diagram illustrating a method for service inspection in accordance with certain embodiments of the present disclosure.

FIG. 2 is a flow diagram illustrating querying an association relationship between a service inspection project and a server in accordance with certain embodiments of the present disclosure.

FIG. 3 is an internal structure diagram illustrating a system for service inspection in accordance with one embodiment of the present disclosure.

FIG. 4 is an internal structure diagram illustrating a system for service inspection in accordance with another embodiment of the present disclosure.

FIG. 5 is an internal structure diagram illustrating a system for service inspection in accordance with still another embodiment of the present disclosure.

FIG. 6 is a time sequence diagram illustrating a system for service inspection in accordance with certain embodiments of the present disclosure.

### DETAILED EMBODIMENTS

The method and system for service inspection of the present disclosure may be best understood by reference to the following description of embodiments taken in conjunction with the accompanying drawings.

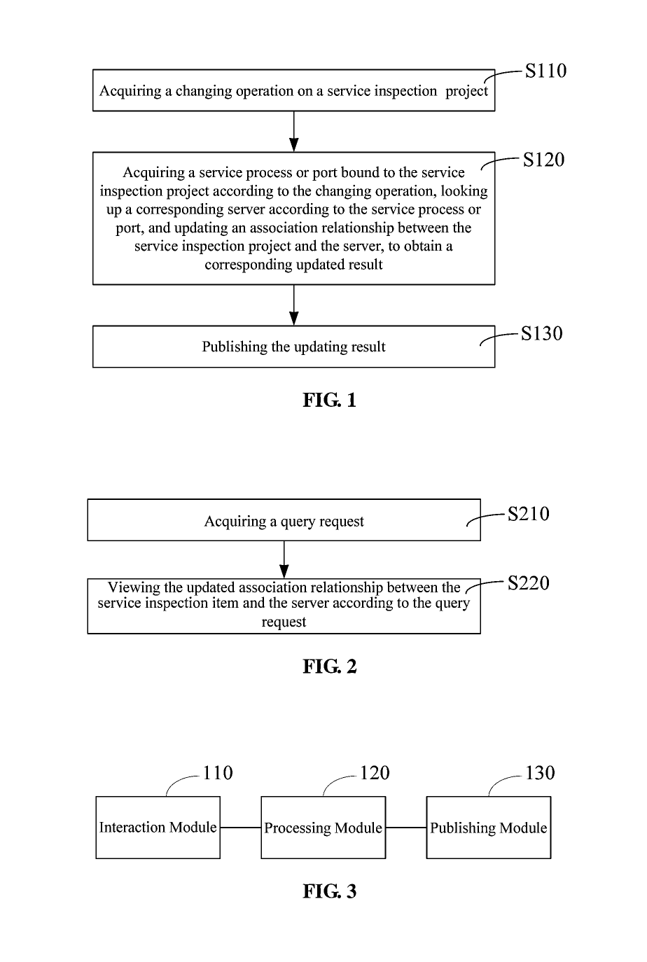

As shown in FIG. 1, in one embodiment, a method for service inspection may include:

Step S110, acquiring a changing operation on a service inspection project.

Specifically, a changing operation on a service inspection project is acquired in a configuration interface of the service inspection. A service inspection project is the smallest program unit for service inspection, which may be bound to a service process or an open port and may be responsible for monitoring the service process or the port. A changing operation may be an adding, editing or deleting operation.

In one embodiment, before the step S110, the method for service inspection may further include: storing information regarding the service inspection project, information regarding the server, and an association relationship between a service inspection project and a server into a service inspection database.

Specifically, the information regarding the service inspection project may include a device's CPU (Central Processing. Unit), hard drive, network condition, and running state of a monitoring service, such as the number of connections of MySQL (My Structured Query Language) or other custom monitoring services. The information regarding the server may include information regarding a service process, information regarding a port registered on the server, and the server's own running state, wherein the information regarding a service process may include a name of the service process, the information regarding a port may include an open port number, and the server's own running state may include being running or being decommissioned. The association relationship between a service inspection project and a server may be apparent as associating an identification of the service inspection project with an identification of the server. The identification of the service inspection project may be used to define a unique identity for the service inspection project, and the identification of the server may be used to define a unique identity for the server.

Step S120, acquiring a service process or port bound to the service inspection project according to the changing operation, looking up a corresponding server according to the service process or port, and updating an association relationship between the service inspection project and the server, to obtain a corresponding updated result.

Specifically, the association relationship may mean a mapping relationship between the service inspection project and the server. The server may be provided with a port or service process, the service inspection project may bind a certain service process or port, and a corresponding server may be found based on the service process or port. The server may be distinguished by IP (Internet Protocol).

Step S130, publishing the updated result.

Specifically, the updated result may be published to a corresponding server by Zookeeper, wherein the Zookeeper is a distributed and open source coordination service for distributed applications including a simple language collection, as an important component of Hadoop and Hbase; is used to solve the consensus problem of the application system in distributed clusters; and can provide data storage, similar to a directory tree style of file system, and maintain and monitor the state change of the stored data. The script program of Zookeeper may include an association relationship between a service inspection project and a server, a corresponding server may be found by the script program based on the identification of the server corresponding to the identification of the service inspection project, and the service inspection project may be published to the server.

When the changing operation is an adding operation, an inspection project for the new service may be registered at first, a service process or port bound to the new service inspection project may be acquired, a corresponding server may be found according to the service process or port, an association relationship between the new service inspection project and the corresponding server may be established, and the new service inspection project may be published to the corresponding server by Zookeeper.

When the changing operation is an editing operation such that a service inspection project is upgraded, a service process or port bound to the service inspection project may be acquired, a corresponding server may be found according to the service process or port, an association relationship between the upgraded service inspection project and the server may be updated, and the upgraded service inspection project may be published to all servers associated with it by Zookeeper to replace original service inspection projects (i.e., monitoring program).

When the changing operation is a deleting operation such that a service inspection project is deleted, a service process or port bound to the service inspection project may be acquired, a corresponding server may be found according to the service process or port, and uninstall operations may be performed in all servers associated with the service inspection project to make the service inspection project no longer operate.

In one embodiment, after publishing the updated result, the method for service inspection may further include: traversing information regarding the service inspection project, information regarding the server, and the association relationship between the service inspection project and the server regularly; and updating an association relationship between the service inspection project and the server according to a result of traverse.

Specifically, the period for traversing may be set upon requirement, for example, once a day. After traversing, the state of the server may be obtained, and whether the association relationship between the service inspection project and the server is valid may be determined.

In one embodiment, updating an association relationship between the service inspection project and the server according to a result of traverse includes:

Step S111, deleting an association relationship in relation to the server when the server is invalid or the server cannot be found.

Specifically, the state of the server may be maintained in a server configuration system. When the server is configured to be invalid in the server configuration system, all association relationships in relation to the server may be deleted. A server that cannot be found means the server is decommissioned (the IP address information of the server does not exist).

Step S112, deleting an association relationship between the server and the corresponding service inspection project when a server port does not match the port bound to the service inspection project or the service process in the server does not match the service process bound to the service inspection project.

Specifically, information regarding a port and a service process of a certain server may be recorded in the server configuration system, which is monitored by a service inspection project, the service inspection project is bound with a port or service process such that an association relationship between the server and the service inspection project may be obtained, and an association relationship between the server and the corresponding service inspection project may be deleted when a server port does not match the port bound to the service inspection project or the service process in the server does not match the service process bound to the service inspection project.

Step S113, establishing an association relationship between a newly-added server and a corresponding service inspection project when adding the new server and there is no association relationship between the new server and the corresponding service inspection project.

Specifically, when finding a new server is added and there is no association relationship between the new server and a corresponding service inspection project after scanning, an association relationship between the newly-added server and the corresponding service inspection project is established automatically.

In one embodiment, before traversing information regarding the service inspection project, information regarding the server, and the association relationship between the service inspection project and the server regularly, the method for service inspection further includes setting up a deleting queue and an adding queue.

Further, the association relationship in step S111 and S112 may be added into the deleting queue, the association relationship in step S113 may be added into the adding queue, association relationships in the deleting queue may be deleted together by traversing the deleting queue, and association relationships in the adding queue may be added together by traversing the adding queue.

Specifically, move an association relationship in relation to the server to the deleting queue when the server is invalid or the server cannot be found; move an association relationship between the server and the corresponding service inspection project to the deleting queue when a server port does not match the port bound to the service inspection project or the service process in the server does not match the service process bound to the service inspection project; move an association relationship between a newly-added server and a corresponding service inspection project when adding the new server and there is no association relationship between the new server and the corresponding service inspection project; traverse the deleting queue, and delete an association relationship between a server and a corresponding service inspection project in the deleting queue; and traverse the adding queue, and add an association relationship between a server and a corresponding service inspection project in the adding queue.

In one embodiment, before acquiring a changing operation on a service inspection project, the method for service inspection further includes: categorizing servers and marking up each category of servers. Specifically, servers are categorized based on similar attributes or functions, and a marker is assigned to each category of servers. An association relationship between the same category of servers and the service inspection project may be established, that is, the servers may be managed according to the categorization of the servers.

Step S120 includes acquiring a service process or port bound to the service inspection project according to the changing operation, looking up a corresponding server according to the service process or port, and updating an association relationship between the service inspection project and each category of servers, to obtain a corresponding updated result.

Specifically, an association relationship between a category of servers and a service inspection project may be updated according to a changing operation; that is, when a service inspection project changes, an association relationship between a category of servers and the service inspection project may change. For example, a category of servers is marked 01, an association relationship between the marker 01 and the service inspection project may be established, and when the service inspection project is updated, the association relationship between the marker 01 and the service inspection project is also updated.

In one embodiment, after publishing the updated result, the method for service inspection further includes:

Step S210, acquiring a query request.

Specifically, the association relationship between the service inspection project and the server may be acquired in the configuration interface for the service inspection.

Step S220, viewing the updated association relationship between the service inspection project and the server according to the query request.

Specifically, the updated association relationship between the service inspection project and the server may be viewed from the service inspection database according to the query request.

Further, in one embodiment, before the step S120, the method for service inspection further includes: storing the updated result into the service inspection database.

Further, in one embodiment, after the step S130, the method for service inspection further includes: reporting the information detected by the inspection project to a visualization system and/or an early warning system.

As shown in FIG. 3, in one embodiment, a system for service inspection includes an interaction module 110, a processing module 120 and a publishing module 130.

The interaction module 110 is configured to acquire a changing operation on a service inspection project. Specifically, acquire a changing operation on a service inspection project in a configuration interface of the service inspection, wherein the service inspection project is the smallest program unit for service inspection which may be bound to a service process or an open port and may be responsible for monitoring the service process or the port. The changing operation may be an adding, editing or deleting operation. In the embodiment, the interaction module 110 is on the configuration system for service inspection.

The processing module 120 is configured to acquire a service process or port that is bound to the service inspection project according to the changing operation, look up a corresponding server according to the service process or port, and update an association relationship between the service inspection project and the server, to obtain a corresponding updated result. Specifically, the association relationship may mean a mapping relationship between the service inspection project and the server. The association relationship between a service inspection project and a server may be apparent as associating an identification of the service inspection project with an identification of the server. The identification of the service inspection project may be used to define a unique identity for the service inspection project, and the identification of the server may be used to define a unique identity for the server. The server may be provided with a port or service process, the service inspection project may bind a certain service process or port, and a corresponding server may be found based on the service process or port.

The server may be distinguished by IP (Internet Protocol). In the embodiment, the processing module 120 is on the configuration system for service inspection.

The publishing module 130 is configured to publish the updated result.

Specifically, the updated result may be published to a corresponding server by Zookeeper, wherein the Zookeeper is a distributed and open source coordination service for distributed applications including a simple language collection, as an important component of Hadoop and Hbase; is used to solve the consensus problem of the application system in distributed clusters; and can provide data storage, similar to a directory tree style of file system, and maintain and monitor the state change of the stored data. The script program of Zookeeper may include an association relationship between a service inspection project and a server, a corresponding server may be found by the script program based on the identification of the server corresponding to the identification of the service inspection project, and the service inspection project may be published to the server.

When the changing operation is an adding operation, the processing module 120 registers the new service inspection project, acquires a service process or port bound to the new service inspection project, finds a corresponding server according to the service process or port, establishes an association relationship between the new service inspection project and the corresponding server, and publishes the new service inspection project to the corresponding server by Zookeeper.

When the changing operation is an editing operation such that a service inspection project is upgraded, the processing module 120 acquires a service process or port bound to the service inspection project, finds a corresponding server according to the service process or port, updates an association relationship between the upgraded service inspection project and the server, and publishes the upgraded service inspection project to all servers associated with the service inspection project by Zookeeper to replace original service inspection projects (i.e., monitoring program).

When the changing operation is a deleting operation such that a service inspection project is deleted, the processing module 120 acquires a service process or port bound to the service inspection project, finds a corresponding server according to the service process or port, performs uninstall operations in all servers associated with the service inspection project to make the service inspection project no longer operate.

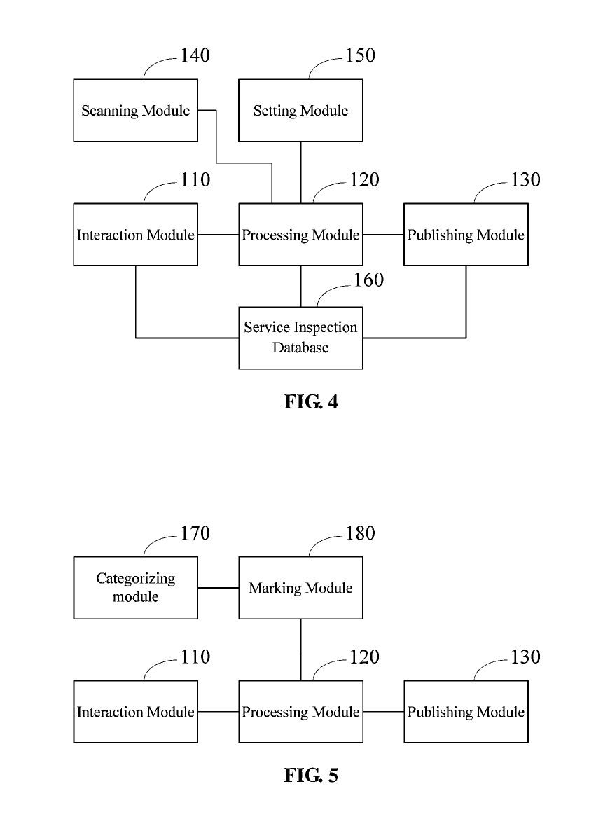

As shown in FIG. 4, in one embodiment, the above system for service inspection includes an interaction module 110, a processing module 120, a publishing module 130, a scanning module 140, a setting module 150 and a service inspection database 160.

The scanning module 140 is configured to traverse information regarding the service inspection project, information regarding the server, and the association relationship between the service inspection project and the server regularly. Specifically, the information regarding the service inspection project may include a device's CPU (Central Processing Unit), hard drive, network condition, and running state of a monitoring service, such as the number of connections of MySQL (My Structured Query Language) or other custom monitoring services. The information regarding the server may include information regarding a service process, information regarding a port registered on the server, and the server's own running state, wherein the information regarding a service process may include a name of the service process, the information regarding a port may include an open port number, and the server's own running state may include being running or being decommissioned. The period for traversing may be set upon requirement, for example, once a day. After traversing, the state of the server may be obtained, and whether the association relationship between the service inspection project and the server is valid may be determined.

The processing module 130 is also configured to update an association relationship between the service inspection project and the server according to a result of traverse.

Specifically, the processing module 130 is also configured to delete an association relationship in relation to the server when the server is invalid or the server cannot be found.

Specifically, the state of the server may be maintained in a server configuration system. When the server is configured to be invalid in the server configuration system, all association relationships in relation to the server may be deleted. A server that cannot be found means the server is decommissioned (the IP address information of the server does not exist).

Further, the processing module 130 is also configured to delete an association relationship between the server and the corresponding service inspection project when a server port does not match the port bound to the service inspection project or the service process in the server does not match the service process bound to the service inspection project.

Specifically, information regarding a port and a service process of a certain server may be recorded in the server configuration system, which is monitored by a service inspection project, the service inspection project is bound with a port or service process such that an association relationship between the server and the service inspection project may be obtained, and an association relationship between the server and the corresponding service inspection project may be deleted when a server port does not match the port bound to the service inspection project or the service process in the server does not match the service process bound to the service inspection project.

Further, the processing module 130 is also configured to establish an association relationship between a newly-added server and a corresponding service inspection project when adding the new server and there is no association relationship between the new server and the corresponding service inspection project.

Specifically, when finding a new server is added and there is no association relationship between the new server and a corresponding service inspection project after scanning, an association relationship between the newly-added server and the corresponding service inspection project is established automatically.

The setting module 150 is configured to set up a deleting queue and an adding queue.

The processing module 130 is also configured to move an association relationship in relation to the server to the deleting queue when the server is invalid or the server cannot be found, move an association relationship between the server and the corresponding service inspection project to the deleting queue when a server port does not match the port bound to the service inspection project or the service process in the server does not match the service process bound to the service inspection project, and move an association relationship between a newly-added server and a corresponding service inspection project when adding the new server and there is no association relationship between the new server and the corresponding service inspection project.

The scanning module 140 is also configured to traverse the deleting queue, and the processing module 130 is also configured to delete an association relationship between a server and a corresponding service inspection project in the deleting queue. The scanning module 140 is also configured to traverse the adding queue, and the processing module 130 is also configured to add an association relationship between a server and a corresponding service inspection project in the adding queue. Association relationships in the deleting queue may be deleted together by traversing the deleting queue, and association relationships in the adding queue may be added together by traversing the adding queue, which improves the operating efficiency.

The scanning module 140 and the setting module 150 are both provided on the configuration system for service inspection.

The service inspection database 160 is configured to store information regarding the service inspection project, information regarding the server, and an association relationship between a service inspection project and a server, before the interaction module acquires a changing operation on a service inspection project. The processing module 130 updates the stored information regarding the service inspection project, information regarding the server, and an association relationship between a service inspection project and a server according to a request for change. In addition, the service inspection database 160 is also configured to store the updated information regarding the service inspection project, information regarding the server, and the association relationship between the service inspection project and the server.

The interaction module 110 is also configured to acquire a query request, and view the updated association relationship between the service inspection project and the server according to the query request. The association relationship between the service inspection project and the server may be acquired in the configuration interface for the service inspection.

In other embodiments, in addition to the interaction module 110, the processing module 120 and the publishing module 130, the system for service inspection may only include a scanning module 140 or a setting module 150 or a service inspection database 160.

As shown in FIG. 5, in one embodiment, the above system for service inspection may include an interaction module 110, a processing module 120, a publishing module 130, a categorizing module 170 and a marking module 180.

The categorizing module 170 is configured to categorize servers. Servers are categorized based on similar attributes or functions.

The marking module 180 is configured to mark up each category of servers. A marker is assigned to each category of servers.

The categorizing module 170 and the marking module 180 are provided on the configuration system for service inspection.

The processing module 130 is also configured to acquire a service process or port that is bound to the service inspection project according to the changing operation, look up a corresponding server according to the service process or port, and update an association relationship between the service inspection project and each category of servers, to obtain a corresponding updated result.

Specifically, an association relationship between a category of servers and a service inspection project may be updated according to a changing operation; that is, when a service inspection project changes, an association relationship between a category of servers and the service inspection project may change. For example, a category of servers is marked 01, an association relationship between the marker 01 and the service inspection project may be established, and when the service inspection project is updated, the association relationship between the marker 01 and the service inspection project is also updated.

In other embodiments, the above system for service inspection may include an interaction module 110, a processing module 120, a publishing module 130, a scanning module 140, a setting module 150, a service inspection database 160, a categorizing module 170 and a marking module 180.

The system for service inspection starts the monitor service after the updated result is published by the publishing module 130, and reports the monitor information to other systems, such as visualization system or early warning system.

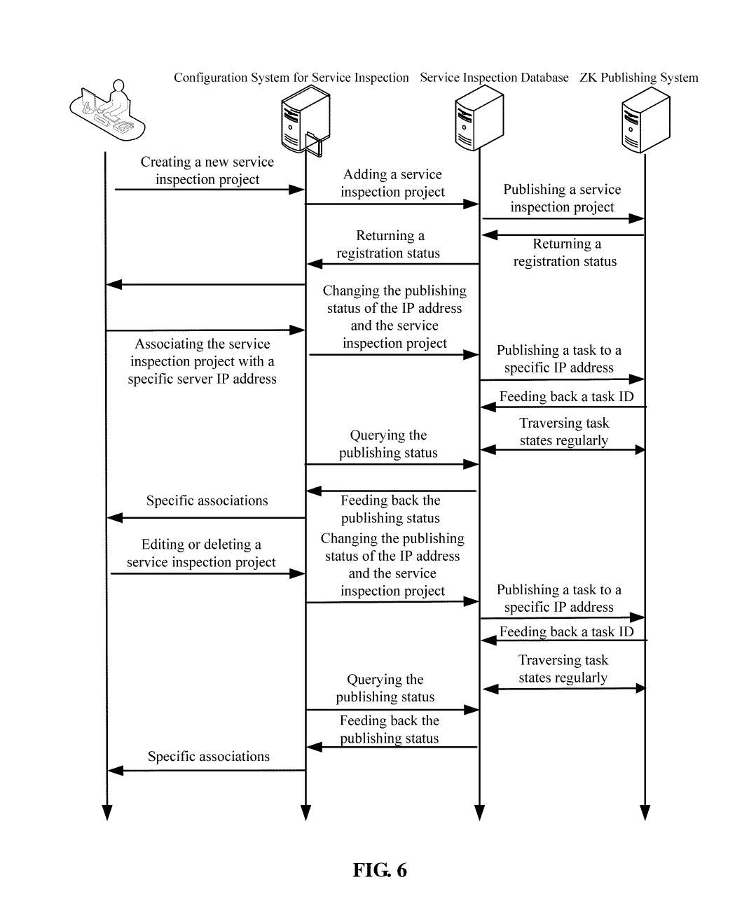

To further illustrate operation processes of the above system for service inspection, as an interaction module 110 and a processing module 120 provided in the configuration system for service inspection, the interaction between the configuration system for service inspection, the service inspection database, and the Zookeeper publishing system is described below, and shown in FIG. 6.

Adding a service inspection project may include:

Step S201, acquiring an operation for creating a new service inspection project in the configuration interface of the configuration system for service inspection.

Step S202, adding the service inspection project to the service inspection database.

Step S203, publishing the service inspection project by a Zookeeper publishing system.

Step S204, returning a registration status to the service inspection database.

Specifically, the created new service inspection project may be registered and stored in the service inspection database.

Step S205, transmitting the registration status to the configuration system for service inspection by the service inspection database.

Specifically, a successful registration status may be returned to the configuration system for service inspection for the user to understand the status.

Associating the service inspection project with a specific server IP address, may include:

Step S206, associating the service inspection project with a specific server IP address in the configuration interface of the configuration system for service inspection.

Specifically, the server may be marked by an IP address, and an association relationship between the service inspection project and the server IP address may be established.

Step S207, storing the publishing status of changing of the IP address and the service inspection project into the service inspection database.

Specifically, after establishing the association relationship between the service inspection project and the server IP address, the association relationship should be stored in the service inspection database. The publishing status describes the association relationship between the service inspection project and the server IP address and the running state of the server.

Step S208, publishing a task to a specific IP address by a Zookeeper publishing system.

Specifically, the service inspection project, which means a task, is a program for monitoring the service and used to monitor a certain service. The service inspection project is deployed to an associated server by a Zookeeper publishing system; that is, a task is published to a specific IP address.

Step S209, feeding a task ID back to the service inspection database.

Specifically, after publishing the task to a specific IP address, the task ID may be fed back and recorded in the service inspection database.

Step S210, traversing task states regularly.

Specifically, the configuration system for service inspection traverses task states regularly by the service inspection database.

Step S211, querying the publishing status in the service inspection database, by the configuration system for service inspection.

Step S212, feeding back the publishing status and specific associations, by the service inspection database.

Editing or deleting a service inspection project may include steps 207 to 212.

In the above method and system for service inspection, by acquiring a service process or port bound to the service inspection project according to the changing operation, looking up a corresponding server according to the service process or port, updating an association relationship between the service inspection project and the server to obtain a corresponding updated result, and publishing the updated result, the service can be updated and maintained automatically to liberate operations staff from redundant work and reduce personnel cost.

In addition, the changing operation may be an adding, editing or deleting operation, or a server being decommissioned, and in these conditions, the system herein may be updated and maintained automatically; an association relationship between the service inspection project and the server which may be incorrect or missed may be further modified by traversing information regarding the service inspection project, information regarding the server, and the association relationship between the service inspection project and the server regularly; and the association relationship between the service inspection project and the server may be accessed to make the operations staff easier to understand.

It will be appreciated for those skilled in the art that parts of or overall process in the above embodiments can be implemented by related hardware controlled by computer program, the computer program can be stored in a non-transitory computer-readable storage medium, and when the computer program is executed, it can include the processes of the above embodiments of each method. Wherein, the non-transitory computer-readable storage medium can be a disc, a compact disc, a Read-Only Memory or a Random Access Memory.

Although the invention herein has been described with reference to various embodiments, it is to be understood that the embodiments are merely illustrative of the principles and applications of the present invention. It is therefore to be understood that a number of variations and modifications may be made to the illustrative embodiments without departing from the inventive spirit and scope of the present disclosure. Accordingly, the scope of the present disclosure is defined by the appended claims rather than the foregoing description and the exemplary embodiments described therein.

What is claimed is:

1. A method for service inspection, comprising:
acquiring a changing operation on a service inspection project;
acquiring a service process or port bound to the service inspection project according to the changing operation, looking up a corresponding server according to the service process or port, and updating an association relationship between the service inspection project and the server to obtain a corresponding updated result; and
publishing the updated result.

2. The method of claim 1, wherein the changing operation is an adding, editing or deleting operation.

3. The method of claim 1, further comprising, after publishing the updated result, the step of:
traversing regularly information regarding the service inspection project, information regarding the server, and the association relationship between the service inspection project and the server; and
updating, according to a result of the traversing, the association relationship between the service inspection project and the server.

4. The method of claim 3, wherein the updating comprises:
deleting an association relationship in relation to the server when the server is invalid or the server cannot be found;
deleting an association relationship between the server and the corresponding service inspection project when a server port does not match the port bound to the service inspection project or the service process in the server does not match the service process bound to the service inspection project; and
establishing an association relationship between a newly-added server and a corresponding service inspection project when adding the new server and there is no association relationship between the new server and the corresponding service inspection project.

5. The method of claim 4, further comprising, before the traversing step, the steps of:
setting up a deleting queue and an adding queue;
moving an association relationship in relation to the server to the deleting queue when the server is invalid or the server cannot be found;
moving an association relationship between the server and the corresponding service inspection project to the deleting queue when a server port does not match the port bound to the service inspection project or the service process in the server does not match the service process bound to the service inspection project;
moving an association relationship between a newly-added server and a corresponding service inspection project to the adding queue when adding the new server and there is no association relationship between the new server and the corresponding service inspection project;
traversing the deleting queue, and deleting an association relationship between a server and a corresponding service inspection project in the deleting queue; and
traversing the adding queue, and adding an association relationship between a server and a corresponding service inspection project in the adding queue.

6. The method of claim 1, further comprising, before acquiring a changing operation on a service inspection project, the step of:
storing information regarding the service inspection project, information regarding the server, and an association relationship between a service inspection project and a server into a service inspection database.

7. The method of claim 1, further comprising, before acquiring a changing operation on a service inspection project, the step of:
categorizing servers and marking up each category of servers; wherein
the step of acquiring a service process or port bound to the service inspection project according to the changing operation, looking up a corresponding server according to the service process or port, and updating an association relationship between the service inspection project and the server to obtain a corresponding updated result comprises:
acquiring a service process or port bound to the service inspection project according to the changing operation, looking up a corresponding category of servers according to the service process or port, and updating an association relationship between the service inspection project and each category of servers to obtain a corresponding updated result.

8. The method of claim 1, further comprising, after publishing the updated result, the steps of:
acquiring a query request; and
viewing the updated association relationship between the service inspection project and the server according to the query request.

9. A system for service inspection, comprising:
an interaction module, configured to acquire a changing operation on a service inspection project;
a processing module, configured to acquire a service process or port bound to the service inspection project according to the changing operation, look up a corresponding server according to the service process or port, and update an association relationship between the service inspection project and the server to obtain a corresponding updated result; and
a publishing module, configured to publish the updated result.

10. The system of claim 9, wherein the changing operation is an adding, editing or deleting operation.

11. The system of claim 9, further comprising:
a scanning module, configured to traverse regularly information regarding the service inspection project, information regarding the server, and the association relationship between the service inspection project and the server;
wherein the processing module is also configured to update an association relationship between the service inspection project and the server according to a result of the traversing.

12. The system of claim 11, wherein the processing module is further configured to delete an association relationship in relation to the server when the server is invalid or the server cannot be found, to delete an association relationship between the server and the corresponding service inspection project when a server port does not match the port bound to the service inspection project or the service process in the server does not match the service process bound to the service inspection project, and to establish an association relationship between a newly-added server and a corresponding service inspection project when adding the new server and there is no association relationship between the new server and the corresponding service inspection project.

13. The system of claim 12, further comprising:
a setting module, configured to set up a deleting queue and an adding queue; wherein
the processing module is also configured to move an association relationship in relation to the server to the deleting queue when the server is invalid or the server cannot be found, to move an association relationship between the server and the corresponding service inspection project to the deleting queue when a server port does not match the port bound to the service inspection project or the service process in the server does not match the service process bound to the service inspection project, and move an association relationship between a newly-added server and a corresponding service inspection project to the adding queue when adding the new server and there is no association relationship between the new server and the corresponding service inspection project;
the scanning module is further configured to traverse the deleting queue, and the processing module is also configured to delete an association relationship between a server and a corresponding service inspection project in the deleting queue; and
the scanning module is further configured to traverse the adding queue, and the processing module is also configured to add an association relationship between a server and a corresponding service inspection project in the adding queue.

14. The system of claim 9, further comprising:
a service inspection database, configured to store information regarding the service inspection project, information regarding the server, and an association relationship between a service inspection project and a server.

15. The system of claim 9, further comprising:
a categorizing module, configured to categorize servers; and
a marking module, configured to mark up each category of servers;
wherein the processing module is further configured to acquire a service process or port that is bound to the service inspection project according to the changing operation, to look up a corresponding server according to the service process or port, and to update an association relationship between the service inspection project and each category of servers, to obtain a corresponding updated result.

16. The system of claim 9, wherein the interaction module is further configured to acquire a query request and view the updated association relationship between the service inspection project and the server according to the query request.

17. A non-transitory computer-readable storage medium comprising computer executable instructions to perform a method for service inspection, wherein the method comprises:
acquiring a changing operation on a service inspection project;
acquiring a service process or port bound to the service inspection project according to the changing operation, looking up a corresponding server according to the service process or port, and updating an association relationship between the service inspection project and the server, to obtain a corresponding updated result; and
publishing the updated result.
